(19) United States
(12) Patent Application Publication
(10) Pub. No.: US 2011/0307935 A1
(43) Pub. Date: Dec. 15, 2011

(54) VIDEO CONTENT DELIVERY OPTIMIZATION OVER MOBILE WIRELESS NETWORKS

(75) Inventor: Lalit R. KOTECHA, San Ramon, CA (US)

(73) Assignee: VERIZON PATENT AND LICENSING INC., Basking Ridge, NJ (US)

(21) Appl. No.: 12/796,991

(22) Filed: Jun. 9, 2010

(51) Int. Cl. H04N 7/173

(52) U.S. Cl. 725/119

(57) ABSTRACT

A device receives, from a fixed user device connected to a wireless network, a request for video content in a particular format, and requests, from a content provider, the requested video content in multiple formats. The device also receives, from the content provider, the video content in multiple formats, and stores the video content in the multiple formats, where the video content in the multiple formats is provided locally to the wireless network.

### BACKGROUND

As wireless network data rates improve using third generation (3G), fourth generation (4G), and WiFi technologies, more and more bandwidth-intensive applications are being developed. Video over the Internet is becoming a significant part of Internet traffic with video portals provided by content providers, such as Hulu™, YouTube, CNN, etc. Video content is also becoming more popular with applications provided via smart phones (e.g., the Motorola DROID, the iPhone, etc.). Much of the video content provided by such content providers and/or applications is high bit rate content that is not optimized for wireless networks. Furthermore, wireless networks may be utilized as a “last mile solution” (e.g., connection between a customer and a telephone company, cable company, and/or service provider) in remote regions (e.g., rural regions) for the delivery of video content, such as television (TV) content (e.g., TV shows, pay-per-view (PPV) content, video-on-demand (VOD) content, etc.).

Wireless service providers have no control over this off-network video content. If content delivery is not optimized for wireless networks, video content may become a choking point for the wireless networks. This may result in poor user experiences and degraded services (e.g., provided by the wireless networks) for other applications like voice-over-Internet protocol (VoIP).

### BRIEF DESCRIPTION OF THE DRAWINGS

FIG. 1 is a diagram of an example network in which systems and/or methods described herein may be implemented;

FIG. 2 is a diagram of example components of one or more of the devices of the network depicted in FIG. 1;

FIG. 3 is a diagram of example interactions between components of an example portion of the network illustrated in FIG. 1;

FIG. 4 is a diagram of example functional components of a video cache engine of the network depicted in FIG. 1;

FIG. 5 is a flow diagram of example interactions between components of the network illustrated in FIG. 1;

FIGS. 6A-6E are diagrams of example interactions between components of another example portion of the network illustrated in FIG. 1;

FIGS. 7A-7D are diagrams of example interactions between components of still another example portion of the network illustrated in FIG. 1; and

FIGS. 8-10 are flow charts of an example process for optimizing video content delivery over mobile wireless networks according to implementations described herein.

### DETAILED DESCRIPTION OF PREFERRED EMBODIMENTS

The following detailed description refers to the accompanying drawings. The same reference numbers in different drawings may identify the same or similar elements. Also, the following detailed description does not limit the invention.

Systems and/or methods described herein may optimize video content delivery over wireless networks. In one example implementation, the systems and/or methods may optimize television video content delivery via a mobile wireless network (e.g., as a last mile solution) to television customers provided in remote regions (e.g., regions that cannot be reached via conventional communication media, such as optical cables, copper cables, and/or other fixed wire-based technologies).

In another implementation, for example, the systems and/or methods may receive, from a fixed user device connected to a mobile wireless network, a request for video content in a particular format (e.g., 1080i, 720p, etc. formats), and may request, from a content provider, the video content in multiple formats. The systems and/or methods may receive the video content in the multiple formats from the content provider. Alternatively, or additionally, the systems and/or methods may receive video content in a single format from the content provider, and may convert the video content from the single format to the multiple formats. The systems and/or methods may provide, to the user device and via the mobile wireless network, the video content in the particular format (e.g., as selected from the multiple format video content). The systems and/or methods may monitor feedback of the provided video content and may monitor conditions (e.g., bandwidth availability, radio conditions, etc.) of the mobile wireless network. The systems and/or methods may modify the format of the video content based on the monitored feedback and/or conditions, and may provide the modified video content to the user device via the mobile wireless network.

As used herein, the terms “customer,” “viewer,” “subscriber,” and/or “user” may be used interchangeably. Also, the terms “customer,” “viewer,” “subscriber,” and/or “user” are intended to be broadly interpreted to include a user device (e.g., a mobile telephone, a personal computer, a set-top box, a television, etc.) or a user of a user device.

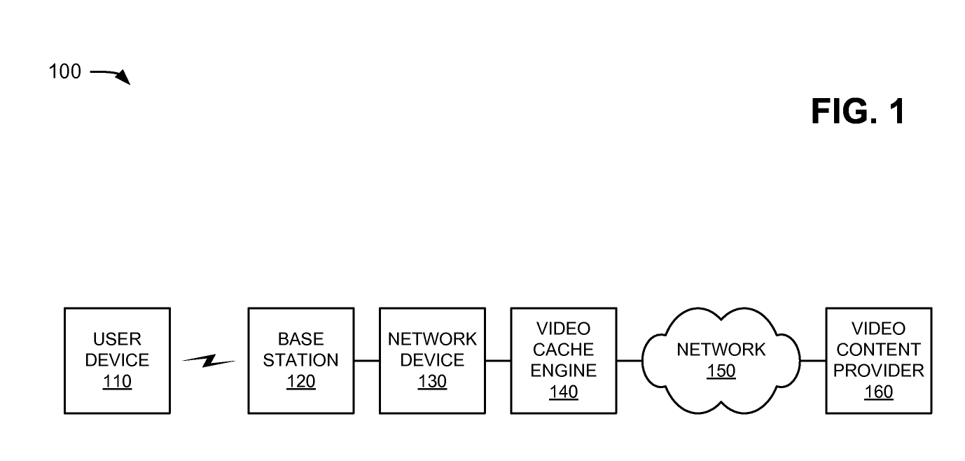

FIG. 1 is a diagram of an example network 100 in which systems and/or methods described herein may be implemented. As illustrated, network 100 may include a user device 110, a base station 120, a network device 130, a video cache engine 140, a network 150, and a video content provider 160. Components of network 100 may interconnect via wired and/or wireless connections. A single user device 110, base station 120, network device 130, video cache engine 140, network 150, and video content provider 160 have been illustrated in FIG. 1 for simplicity. In practice, there may be more user devices 110, base stations 120, network devices 130, video cache engines 140, networks 150, and video content providers 160.

User device 110 may include any device that is capable of communicating with video cache engine 140 via a wireless network (e.g., provided by base station 120 and/or network device 130). For example, user device 110 may include a mobile computation and/or communication device, such as a radiotelephone, a personal communications system (PCS) terminal (e.g., that may combine a cellular radiotelephone with data processing and data communications capabilities), a personal digital assistant (PDA) (e.g., that can include a radiotelephone, a pager, Internet/intranet access, etc.), a wireless device, a smart phone, a laptop computer (e.g., with a wireless air card), a global positioning system (GPS) device, a content recording device (e.g., a camera, a video camera, etc.), etc. In another example, user device 110 may include a fixed (e.g., provided in a particular location, such as within a customer's home) computation and/or communication device, such as a laptop computer, a personal computer, a tablet computer, a set-top box (STB), a television, a gaming system, etc.

Base station 120 may include one or more computation and/or communication devices that receive voice and/or data (e.g., video content) from video cache engine 140 (e.g., via network device 130) and transmit that voice and/or data to user device 110. Base station 120 may also include one or more devices that receive voice and/or data (e.g., a request for video content) from user device 110 and transmit that voice and/or data to video cache engine 140 (e.g., via network device 130).

Network device 130 may include one or more data transfer devices, such as a gateway, a router, a switch, a firewall, a network interface card (NIC), a hub, a bridge, a proxy server, an optical add-drop multiplexer (OADM), or some other type of device that processes and/or transfers data. In one example, network device 130 may include a mobile wireless gateway that provides a convergence point between wireless protocols (e.g., associated with user device 110 and/or base station 120) and IP protocols (e.g., associated with video cache engine 140, network 150, and/or video content provider 160). The mobile wireless gateway may route packets (or portions of packets) from a wireless network (e.g., user device 110 and base station 120) to another network (e.g., network 150). The mobile wireless gateway may combine functions of a wireless access point, a router, and a firewall, and may be referred to as a “converged device.” In one implementation, network device 130 may receive requests for video content from user device 110 (e.g., via base station 120), and may provide the requests for video content to video cache engine 140. Network device 130 may receive the requested video content from video cache engine 140, and may provide the video content to user device 110 (e.g., via base station 120).

Video cache engine 140 may include one or more server devices, or other types of computation or communication devices, that gather, process, and/or provide information in a manner described herein. Video cache engine 140 may include a device that is capable of communicating with user device 110 (e.g., via base station 120 and network device 130) and video content provider 160 (e.g., via network 150). In one example, video cache engine 140 may include a server device, a laptop computer, a personal computer, a workstation computer, etc. In another example, video cache engine 140 may be part of a wireless service provider network (e.g., that includes base station 120 and/or network device 130), and may cache video content (e.g., in multiple formats) locally to the wireless service provider network. By storing video content locally, video cache engine 140 may efficiently provide video content to user device 110 without being dependent upon network 150 and/or video content provider 160.

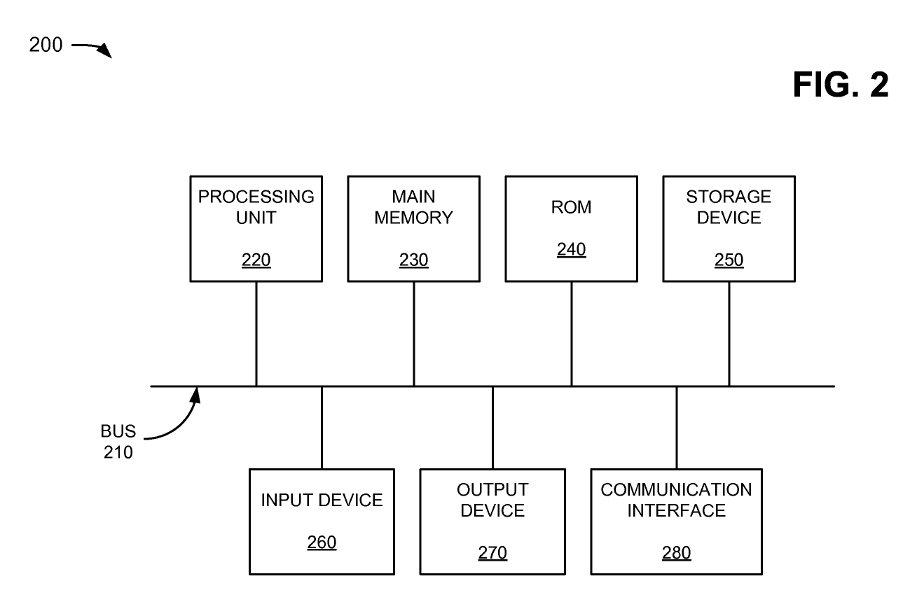

In one implementation, video cache engine 140 may receive, from user device 110 associated with a mobile wireless network (e.g., provided by base station 120 and/or network device 130), a request for video content in a particular format, and may request, from video content provider 160, the video content in multiple formats. Video cache engine 140 may receive the video content in the multiple formats from video content provider 160. Alternatively, or additionally, video cache engine 140 may receive video content in a single format from video content provider 160, and may convert the video content from the single format to the multiple formats. Video cache engine 140 may provide, to user device 110 and via the mobile wireless network, the video content in the particular format (e.g., as selected from the multiple format video content). Video cache engine 140 may monitor feedback of the provided video content and may monitor conditions (e.g., bandwidth availability, radio conditions, etc.) of the mobile wireless network. Video cache engine 140 may modify the format of the video content based on the monitored feedback and/or conditions, and may provide the modified video content to user device 110 via the mobile wireless network. Further details of video cache engine 140 are provided below in connection with, for example, FIGS. 2-5.

Network 150 may include a local area network (LAN), a wide area network (WAN), a metropolitan area network (MAN), a telephone network, such as the Public Switched Telephone Network (PSTN), an intranet, the Internet, an optical fiber (or fiber optic)-based network, a cable television network, a satellite television network, or a combination of networks.

Video content provider 160 may include one or more server devices, or other types of computation or communication devices, that gather, process, search, and/or provide information in a manner described herein. In one implementation, video content provider 160 may include a computer system, an application, a cable head-end, and/or a broadcasting device capable of providing video content (e.g., VOD content, high definition (HD)-VOD content, TV programming, movies, on-demand services, live television, etc.) in a variety of formats (e.g., 1080p, 1080i, 720p, 720i, 480p, 480i, 360p, 360i, etc. formats), commercials, advertisements, instructions, and/or other information. “1080p,” for example, may be a shorthand identification for a category of HDTV video modes (e.g., where “1080” may represent 1,080 lines of vertical resolution (1,080 horizontal scan lines) and the letter “p” may stand for progressive scan (meaning the image is not interlaced). “1080i,” for example, may include the same features as “1080p,” but the letter “i” may mean that the image is interlaced.

Although FIG. 1 shows example components of network 100, in other implementations, network 100 may contain fewer components, different components, differently arranged components, and/or additional components than those depicted in FIG. 1. Alternatively, or additionally, one or more components of network 100 may perform one or more other tasks described as being performed by one or more other components of network 100.

FIG. 2 is an example diagram of a device 200 that may correspond to one or more of the devices of network 100. As illustrated, device 200 may include a bus 210, a processing unit 220, a main memory 230, a read-only memory (ROM) 240, a storage device 250, an input device 260, an output device 270, and/or a communication interface 280. Bus 210 may include a path that permits communication among the components of device 200.

Processing unit 220 may include one or more processors, microprocessors, or other types of processing units that may interpret and execute instructions. Main memory 230 may include one or more random access memories (RAMs) or other types of dynamic storage devices that may store information and instructions for execution by processing unit 220. ROM 240 may include one or more ROM devices or other types of static storage devices that may store static information and/or instructions for use by processing unit 220. Storage device 250 may include a magnetic and/or optical recording medium and its corresponding drive.

Input device 260 may include a mechanism that permits a user to input information to device 200, such as a keyboard, a mouse, a pen, a microphone, voice recognition and/or biometric mechanisms, a remote control, a touch screen, etc. Output device 270 may include a mechanism that outputs information to the user, including a display, a printer, a speaker, etc. Communication interface 280 may include any transceiver-like mechanism that enables device 200 to communicate with other devices, networks, and/or systems. For example, communication interface 280 may include mechanisms for communicating with another device or system via a network.

As described herein, device 200 may perform certain operations in response to processing unit 220 executing software instructions contained in a computer-readable medium, such as main memory 230. A computer-readable medium may be defined as a physical or logical memory device. A logical memory device may include memory space within a single physical memory device or spread across multiple physical memory devices. The software instructions may be read into main memory 230 from another computer-readable medium, such as storage device 250, or from another device via communication interface 280. The software instructions contained in main memory 230 may cause processing unit 220 to perform processes described herein. Alternatively, hardwired circuitry may be used in place of or in combination with software instructions to implement processes described herein. Thus, implementations described herein are not limited to any specific combination of hardware circuitry and software.

Although FIG. 2 shows example components of device 200, in other implementations, device 200 may contain fewer components, different components, differently arranged components, and/or additional components than depicted in FIG. 2. Alternatively, or additionally, one or more components of device 200 may perform one or more other tasks described as being performed by one or more other components of device 200.

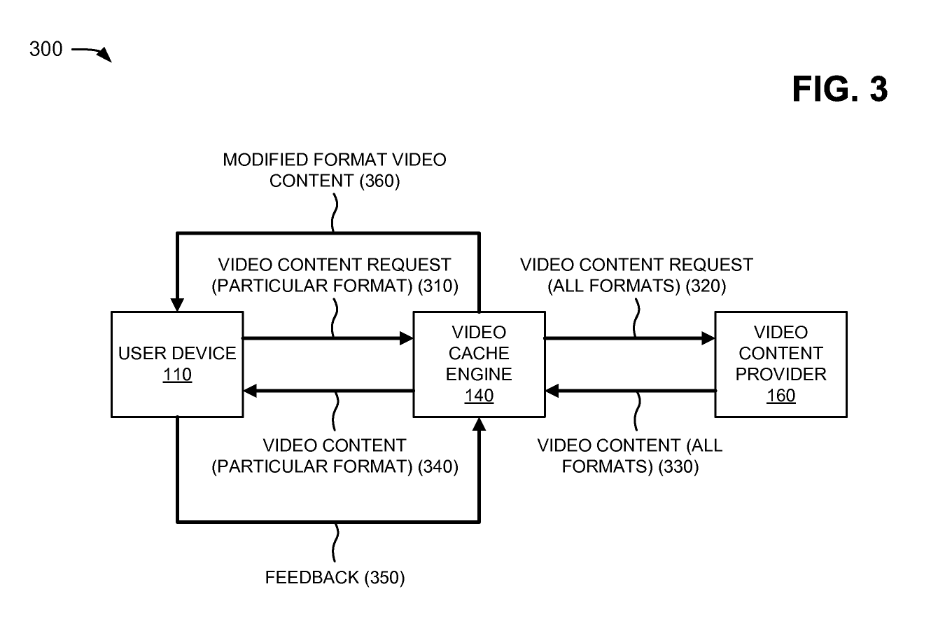

FIG. 3 is a diagram of example interactions between components of an example portion 300 of network 100. As illustrated, example network portion 300 may include user device 110, video cache engine 140, and video content provider 160. User device 110, video cache engine 140, and video content provider 160 may include the features described above in connection with one or more of FIGS. 1 and 2.

As further shown in FIG. 3, a user (not shown) may utilize user device 110 to generate a request 310 for video content (e.g., in a particular format, such as a 1080i format) to be displayed on user device 110. For example, the user may be connected to a web site (e.g., YouTube) of the Internet (e.g., via user device 110), and may select a video provided by the web site. User device 110 may wirelessly provide (e.g., via base station 120 and/or network device 130, not shown) video content request 310 to video cache engine 140. Video content cache engine 140 may receive video content request 310 from user device 110, and may generate a request 320 for the video content (e.g., in all available or multiple formats, such as the 1080p, 1080i, 760p, 760i, etc. formats) based on video content request 310. For example, if the user requests (e.g., via video content request 310) video content in a 760p format, video cache engine 140 may request (e.g., via video content request 320) video content in 1080p, 1080i, 760p, 760i, 480p, and 480i formats. Video cache engine 140 may provide video content request 320 to video content provider 160. Alternatively, if the video content requested by video content request 310 is already cached in video cache engine 140, video cache engine 140 may not generate video content request 320, but may retrieve the cached video content and render the video content to user device 110.

Video content provider 160 may receive video content request 320, may search for the requested video content and formats (e.g., provided via request 320), and may provide the requested video content in all formats (e.g., available at video content provider 160) to video cache engine 140, as indicated by reference number 330. For example, video content provider 160 may provide (e.g., to video cache engine 140) video content 330 in 1080p, 1080i, 760p, 760i, 480p, and 480i formats. Video cache engine 140 may receive video content 330 (e.g., in multiple formats), and may retrieve the particular format requested by the user (e.g., via video content request 310) from the multiple formats of video content 330. Video cache engine 140 may provide the video content (e.g., in the particular format) to user device 110, as indicated by reference number 340. User device 110 may receive video content 340 and may display video content 340 to the user and in the particular format.

As further shown in FIG. 3, video cache engine 140 may monitor feedback 350 provided by user device 110. Feedback 350 may include information associated with video content 340, such as whether user device 110 is receiving video content 340 at a particular bit rate, quality level, etc.; whether user device 110 can support video content 340 in the particular format; etc. Feedback 350 may also include information associated with conditions (e.g., radio conditions, bandwidth availability, etc.) of the wireless network provided by base station 120 to user device 110. Video cache engine 140 may modify the format of video content 340 based on the monitored feedback 350. For example, if video cache engine 140 determines that radio conditions are deteriorating between user device 110 and base station 120 (e.g., such that user device 110 cannot properly display 1080i format video content), video cache engine 140 may modify the format of the video content to a 720i format. Video cache engine 140 may provide the modified video content to user device 110 (e.g., via base station 120 and network device 130, not shown), as indicated by reference number 360. User device 110 may receive modified format video content 360 and may display video content 360 to the user and in the modified format (e.g., without disrupting the video stream).

Although FIG. 3 shows example components of network portion 300, in other implementations, network portion 300 may contain fewer components, different components, differently arranged components, and/or additional components than depicted in FIG. 3. Alternatively, or additionally, one or more components of network portion 300 may perform one or more other tasks described as being performed by one or more other components of network portion 300.

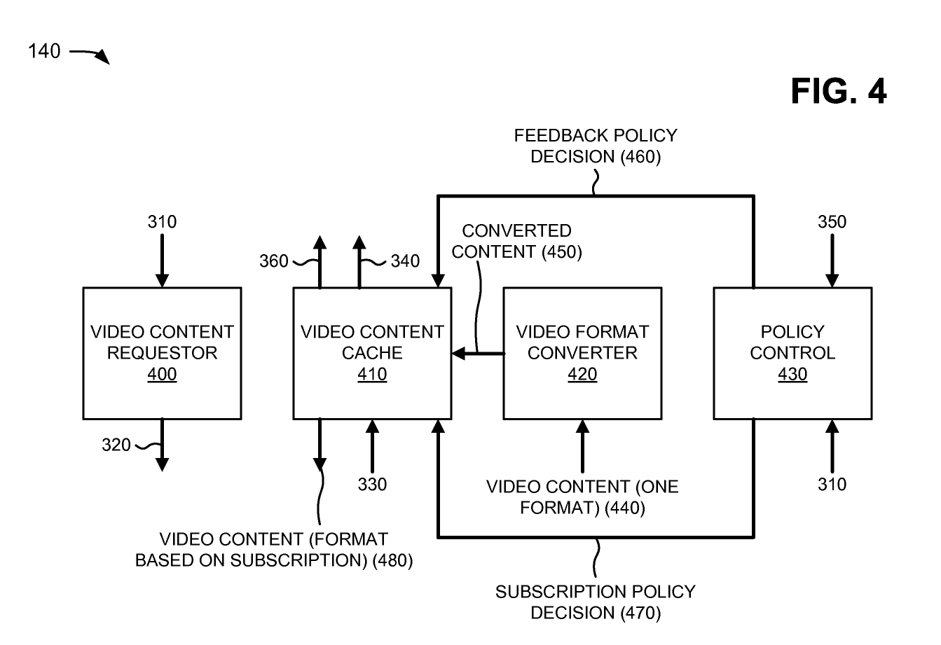

FIG. 4 is a diagram of example functional components of video cache engine 140. In one implementation, the functions described in connection with FIG. 4 may be performed by one or more components of device 200 (FIG. 2). As shown in FIG. 4, video cache engine 140 may include a video content requestor 400, a video content cache 410, a video format converter 420, and a policy control component 430.

Video content requestor 400 may include hardware or a combination of hardware and software that may receive video content request 310 (e.g., for video content in the particular format) from user device 110, and may generate video content request 320 (e.g., for video content in all formats). Video content requestor 400 may provide video content request 320 to video content provider 160.

Video content cache 410 may include hardware or a combination of hardware and software that may receive video content 330 (e.g., in all formats) from video content provider 160, and may store (or cache) video content 330. Video content cache 410 may determine the requested format from video content 330, and may provide video content 340 (e.g., in the particular format requested by user device 110) to user device 110. Video content cache 410 may cache video content 330 when a user associated with user device 110 requests video content 330 or automatically (e.g., without the user requesting video content 330). Video content cache 410 may cache video content 330 (e.g., in multiple formats) locally to the wireless network (e.g., provided by base station 120 and/or network device 130). Such local caching of video content 330 may increase bandwidth availability in the wireless network and/or network 150. Video content cache 410 may interact with video content converter 420 and/or policy control component 430, as described below.

Video format converter 420 may include hardware or a combination of hardware and software that may receive video content 440 (e.g., in a single format or less than all available formats) from video content provider 160 (e.g., if video content provider 160 does not provide video content in all formats). Video format converter 420 may convert video content 440 (e.g., in the single format) into video content (e.g., in all formats), and may provide the converted video content to video content cache 410 (e.g., for storage locally to the wireless network provided by base station 120 and/or network device 130), as indicated by reference number 450. Video content cache 410 may determine the requested format from converted video content 450, and may provide video content (e.g., in the particular format requested by user device 110) to user device 110.

Policy control component 430 may include hardware or a combination of hardware and software that may receive video content request 310 from user device 110, and may identify a user of user device 110 based on video content request 310. For example, video content request 310 may identify the user of user device 110 (e.g., based on device identification, a user name, login identification, a telephone number, etc.), and policy control component 430 may determine subscription information (e.g., whether the user has a subscription to view higher quality video content or lower quality video content) based on the identification. Policy control component 430 may also receive feedback 350 from user device 110. Policy control component 430 may determine a feedback policy decision 460 based on feedback 350 and/or may determine a subscription policy decision 470 based on identification of the user (e.g., and the determined subscription information). Feedback policy decision 460 may include a decision to modify video content 340 provided to user device 110 based on feedback 350 (e.g., based on a lack of bandwidth available to provide video content 340 in a particular format). Subscription policy decision 470 may include a decision to modify video content based on the determined subscription information (e.g., based on whether the user subscribes to higher quality video content or lower quality video content). In one implementation, subscription policy decision 470 may include a decision to deliver better quality video content (e.g., 1080p format) to premium subscribers and lower quality video content (e.g., 720p format) to standard subscribers. For example, if two subscribers (e.g., a premium subscriber and a standard subscriber) request the same video content in 1080p format, the premium may receive 1080p format video content and the standard subscriber may receive 720p format video content.

As further shown in FIG. 4, policy control component 430 may provide feedback policy decision 460 and/or subscription policy decision 470 to video content cache 410, and video content cache 410 may modify the format of video content 340 based on feedback policy decision 460 and/or subscription policy decision 470. In one implementation, video content cache 410 may modify the format of video content 340 based on feedback policy decision 460 to produce modified format video content 360. Video content cache 410 may provide modified format video content 360 to user device 110. In another implementation, video content cache 410 may generate video content 480 (e.g., in a format based on subscription policy decision 470). For example, if the user of user device 110 subscribes to higher quality (e.g., a 1080p format) video content, video content 480 may be provided in the higher quality format to user device 110.

Although FIG. 4 shows example functional components of video cache engine 140, in other implementations, video cache engine 140 may contain fewer functional components, different functional components, differently arranged functional components, and/or additional functional components than depicted in FIG. 4. Alternatively, or additionally, one or more functional components of video cache engine 140 may perform one or more other tasks described as being performed by one or more other functional components of video cache engine 140.

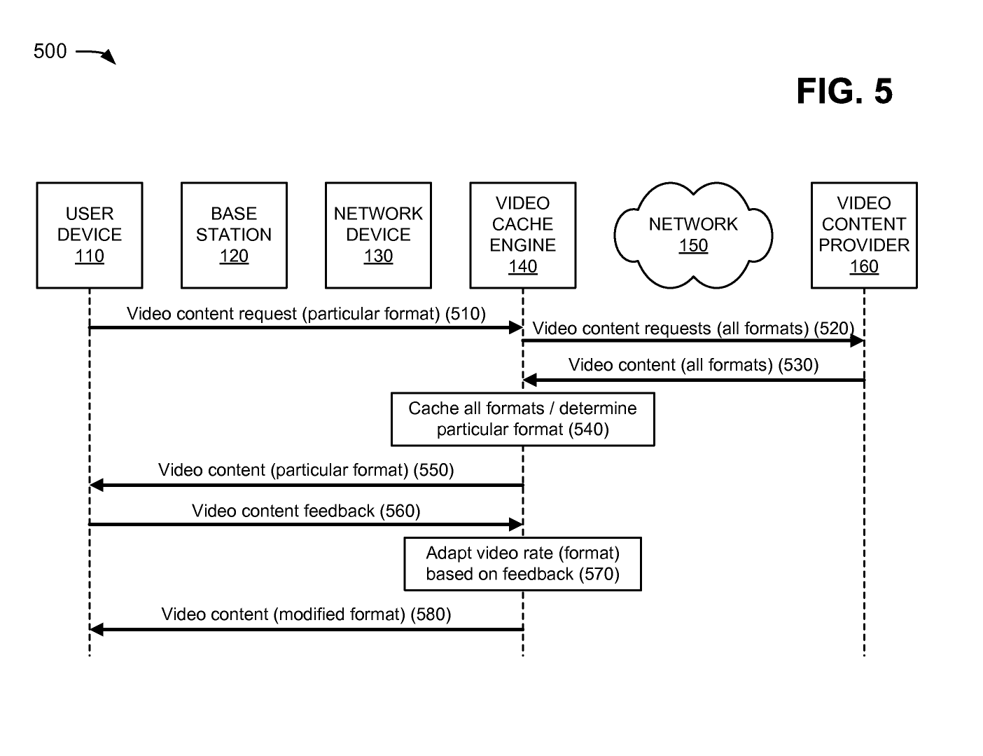

FIG. 5 is a flow diagram of example interactions 500 between components of network 100. Components of network 100 (e.g., depicted in FIG. 5) may include the features described above in connection with one or more of FIGS. 1-4.

With reference to FIG. 5, when user device 110 is connected to the wireless network (e.g., base station 120 and/or network device 130), user device 110 may generate a video content request 510 (e.g., for video content in a particular format), and may provide video content request 510 to video cache engine 140 (e.g., via base station 120 and network device 130). In one example, video content request 510 may include a uniform resource locator (URL)-based request or other similar web-based request for video content in a particular format (e.g., 1080i format).

Video cache engine 140 may receive video content request 510, and may generate multiple video content requests 520 (e.g., to obtain the requested video content in all available formats) based on video content request 510. For example, if video content request 510 requests video content in a 1080i format, video cache engine 140 may generate multiple video content requests 520 for the video content in 1080p, 1080i, 720p, 720i, 480p, 480i, etc. formats. Alternatively, or additionally, video content request 520 may include a request for the video content in an available format with the highest quality. For example, if video content request 510 requests video content in a 720i format, video cache engine 140 may generate video content request 520 for the video content in a 1080p format. As further shown in FIG. 5, video cache engine 140 may provide video content requests 520 to video content provider 160 (e.g., via network 150). Alternatively, if the video content requested by video content request 510 is already cached in video cache engine 140, video cache engine 140 may not generate video content requests 520, but may retrieve the cached video content and render the video content to user device 110.

Video content provider 160 may provide video content 530 (e.g., in the format(s) requested by video content requests 520) to video cache engine 140 (e.g., via network 150). In one implementation, video content 530 may include the video content (e.g., requested by video content request 510) provided in all available formats (e.g., 1080p, 1080i, 720p, etc.). In another implementation, video content 530 may include the video content (e.g., requested by video content request 510) provided in an available format with the highest quality (e.g., the 1080p format). In such an implementation, video cache engine 140 (e.g., video format converter 420) may convert the video content provided in the single format (e.g., the 1080p format) to video content provided in all possible formats (e.g., 1080p, 1080i, 720p, etc.).

As further shown in FIG. 5, video cache engine 140 may cache (or store) video content 530 (e.g., in all possible formats and locally to the wireless network provided by base station 120 and/or network device 130), and may determine or select (e.g., from video content 530) the video content in the particular format requested by video content request 510, as indicated by reference number 540. Video cache engine 140 may provide the video content (e.g., in the particular format requested by video content request 510) to user device 110 (e.g., via the wireless network provided by base station 120 and/or network device 130), as indicated by reference number 550. User device 110 may receive video content 550 and may display video content 550 to the user and in the particular format.

If user device 110 is mobile, radio conditions between user device 110 and base station 120 may continuously change. Alternatively, or additionally, if a load on base station 120 varies (e.g., based on bandwidth usage of other subscribers, time of day, etc.), radio conditions between user device 110 and base station 120 may change. Such changes may result in the wireless network (e.g., provided by base station 120 and/or network device 130) becoming congested, which may result in slower delivery of video content 550 to user device 110. This information (e.g., radio conditions, load on base station 120, wireless network congestion, etc.) may be provided from user device 110 to video cache engine 140 (e.g., via base station 120 and network device 130) as video content feedback 560. Based on video content feedback 560, video cache engine 140 may dynamically adapt a rate (e.g., a format or a quality) of video content 550 delivered to user device 110, as indicated by reference number 570. For example, if the radio conditions (e.g., between user device 110 and base station 120) deteriorate, video content 550 may be changed from a 1080i format (e.g., a higher quality format) to a 360p format (e.g., a lower quality format). In another example, if the radio conditions (e.g., between user device 110 and base station 120) improve, video content 550 may be changed from a 1080i format (e.g., a lower quality format) to a 1080p format (e.g., a higher quality format). Video cache engine 140 may provide video content (e.g., in the modified format) to user device 110 (e.g., via base station 120 and network device 130), as indicated by reference number 580.

In one example implementation, video cache engine 140 may utilize policy control component 430 (FIG. 4) to identify a subscription level of the user before deciding to what level of video quality to modify video content 550. For example, a premium subscriber may be able to receive higher quality (e.g., 720p format) modified video content 580 than a standard subscriber (e.g., who may receive 360i format video content) receives when the wireless network (e.g., provided by base station 120 and/or network device 130) is congested.

Although FIG. 5 shows example components of network 100, in other implementations, network 100 may contain fewer components, different components, differently arranged components, and/or additional components than depicted in FIG. 5. Alternatively, or additionally, one or more components of network 100 may perform one or more other tasks described as being performed by one or more other components of network 100. Furthermore, although FIG. 5 shows example interactions 500 among components of network 100, in other implementations, components of network 100 may perform fewer interactions, different interactions, and/or additional interactions than depicted in FIG. 5.

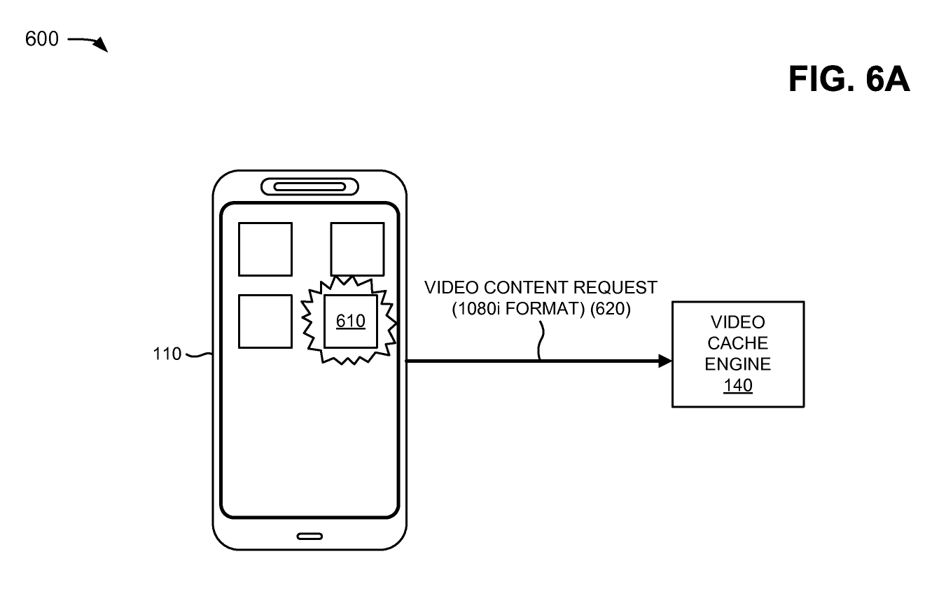

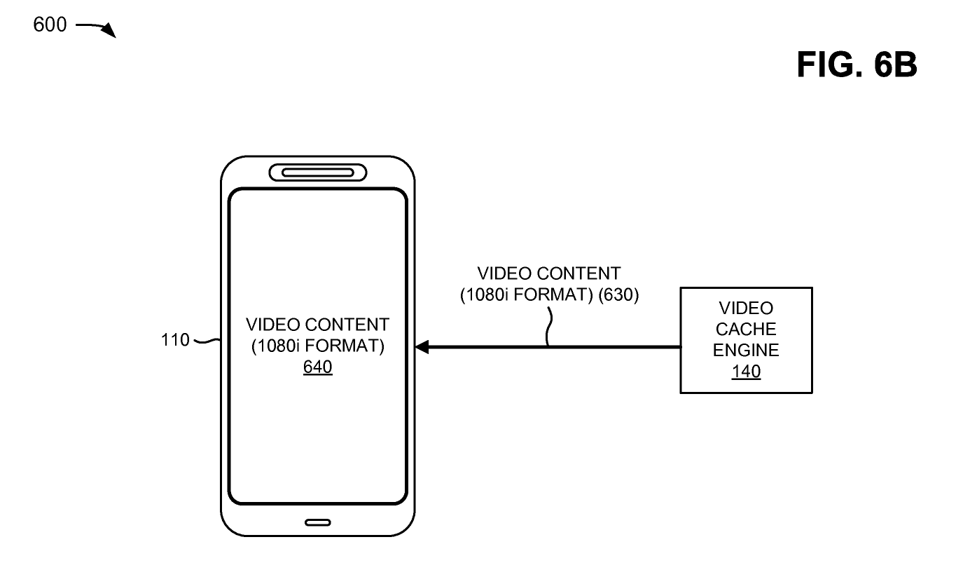

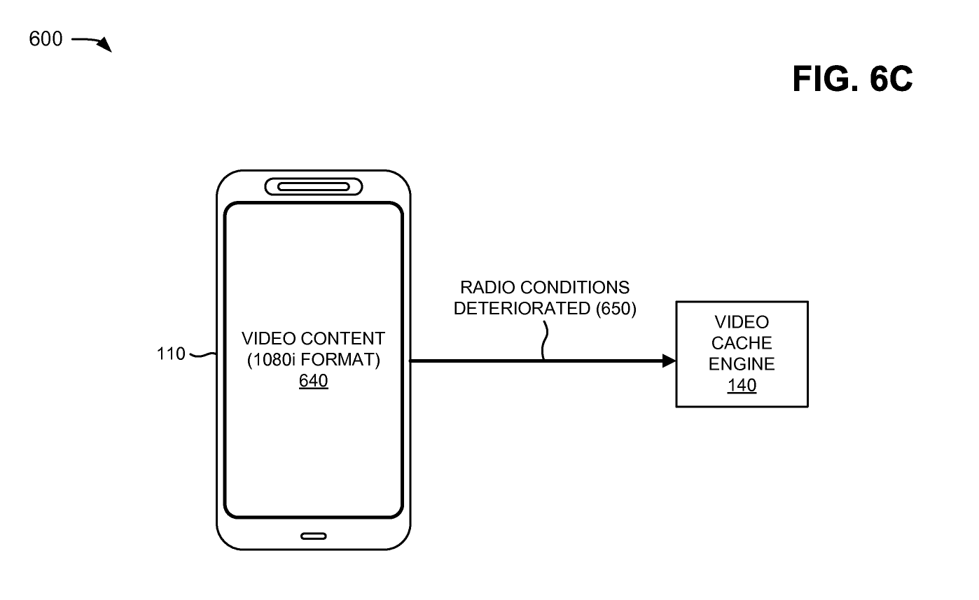

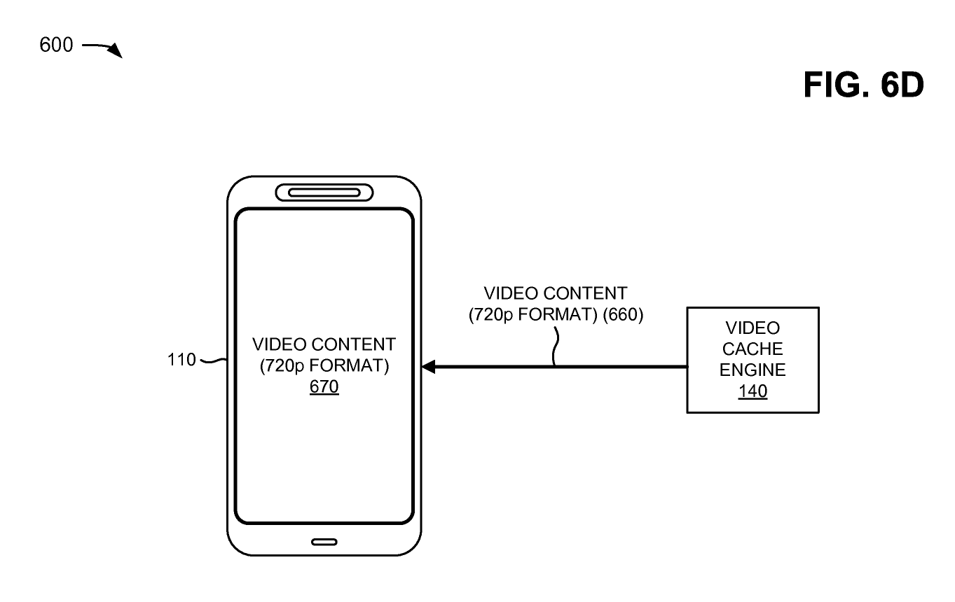

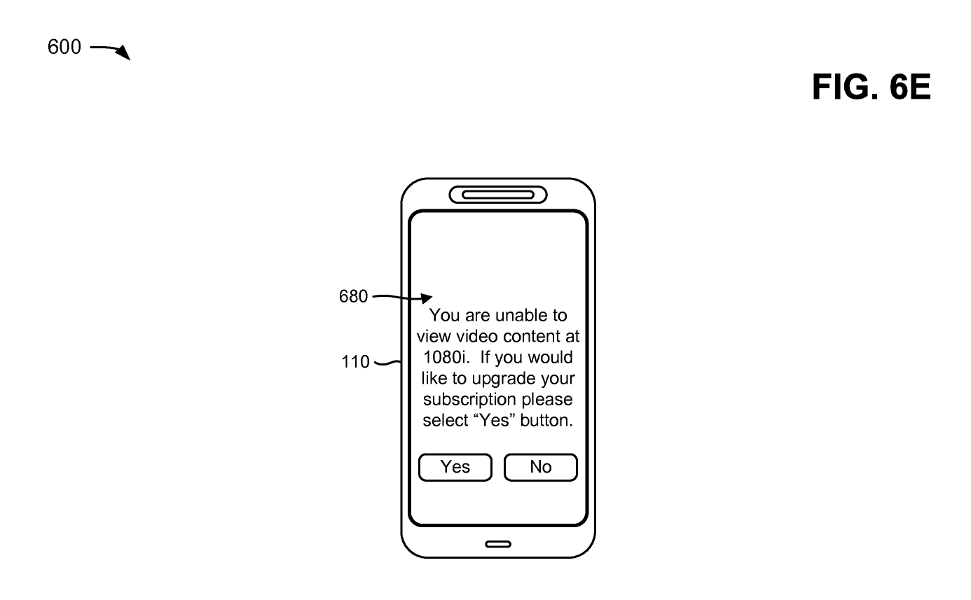

FIGS. 6A-6E are diagrams of example interactions between components of another example portion 600 of network 100. As illustrated, example network portion 600 may include user device 110 and video cache engine 140. User device 110 and video cache engine 140 may include the features described above in connection with one or more of FIGS. 1-5. Furthermore, user device 110 depicted in FIGS. 6A-6E may correspond to a mobile communication device, such as a mobile telephone.

With reference to FIG. 6A, a user of user device 110 may access a video content service (e.g., provided by video content provider 160 to user device 110 via base station 120, network device 130, and/or network 150), and may be presented a variety of videos that may be displayed on (e.g., streamed to) user device 110. As shown in FIG. 6A, if the user selects a video 610 from the variety of videos, user device 110 may generate a video content request 620 (e.g., in the 1080i format) for the selected video 610. User device 110 may provide video content request 620 to video cache engine 140 (e.g., via base station 120 and/or network device 130, not shown).

Video cache engine 140 may receive video content request 620 from user device 110, may generate a request for the video content (e.g., in all formats, such as 1080p, 1080i, 760p, 760i, etc.) based on video content request 620, and may provide the request (e.g., for video content in all formats) to video content provider 160 (not shown). Video content provider 160 may provide the requested video content (e.g., in all formats) to video cache engine 140. Video cache engine 140 may determine video content 630 (e.g., in the requested 1080i format) from the video content (e.g., in all formats) received from video content provider 160, and may provide video content 630 to user device 110 (e.g., via base station 120 and/or network device 130, not shown), as shown in FIG. 6B. User device 110 may receive video content 630 from video cache engine 110 and may display video content 630 (e.g., in the 1080i format) on its display screen, as indicated by reference number 640.

If radio conditions between user device 110 and base station 120 deteriorate (e.g., due to user device 110 mobility, increased bandwidth usage, etc.), user device 110 may provide an indication 650 of the radio conditions deteriorating to vide cache engine 140, as shown in FIG. 6C. Based on indication 650, video cache engine 140 may dynamically adapt a rate (e.g., a format or a quality) of video content 630 delivered to user device 110. For example, if the radio conditions (e.g., between user device 110 and base station 120) deteriorate, video cache engine 140 may change video content 630 from a 1080i format (e.g., a higher quality format) to video content 660 in a 720p format (e.g., a lower quality format). As shown in FIG. 6D, video cache engine 140 may provide video content 660 (e.g., in the 720p format) to user device 110, and user device 110 may display video content 660 on its display screen, as indicated by reference number 670.

With reference to FIG. 6E, prior to video content 630 being provided to user device 110 (e.g., as shown in FIG. 6B), video cache engine 140 may determine whether the user subscribes to a service that enables viewing video content 630 in the 1080i format. For example, if video cache engine 140 determines that the user does not subscribe to a service that enables viewing video content 630 in the 1080i format, video cache engine 140 may provide an indication of this to user device 110, and user device 110 may display a user interface 680 on its display screen. User interface 680 may include information about the user's subscription (e.g., “You are unable to view video content at 1080i. If you would like to upgrade your subscription please select ‘Yes’ button.”) and mechanisms (e.g., buttons, icons, etc.) permitting the user to upgrade the subscription.

Although FIGS. 6A-6E show example components of network portion 600, in other implementations, network portion 600 may contain fewer components, different components, differently arranged components, and/or additional components than depicted in FIGS. 6A-6E. Alternatively, or additionally, one or more components of network portion 600 may perform one or more other tasks described as being performed by one or more other components of network portion 600.

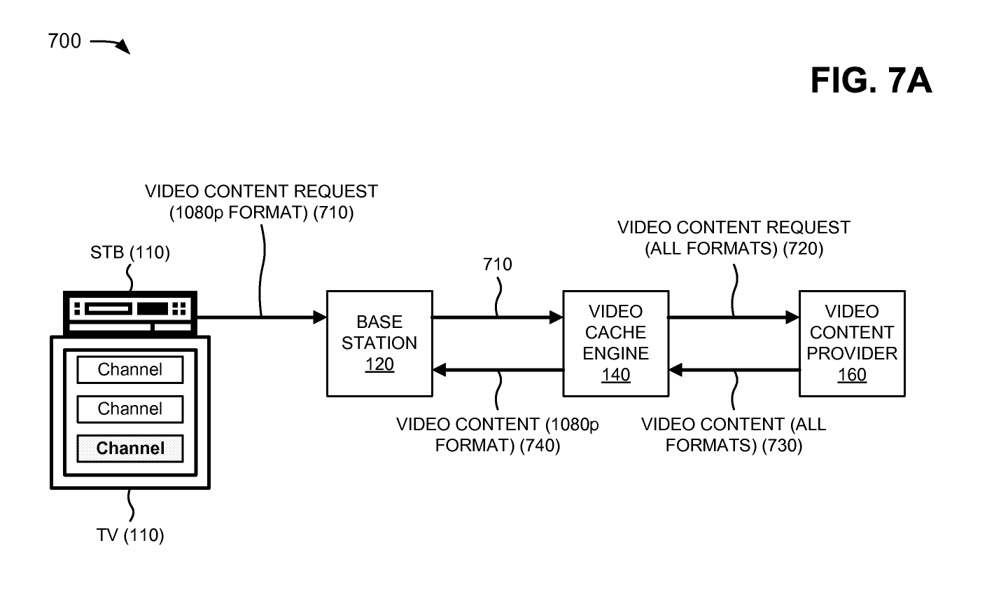

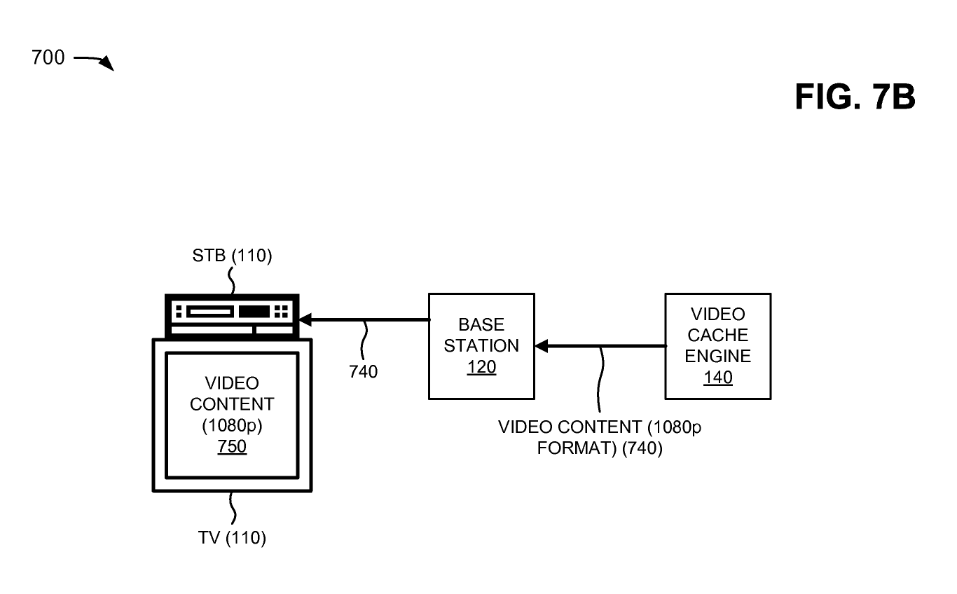

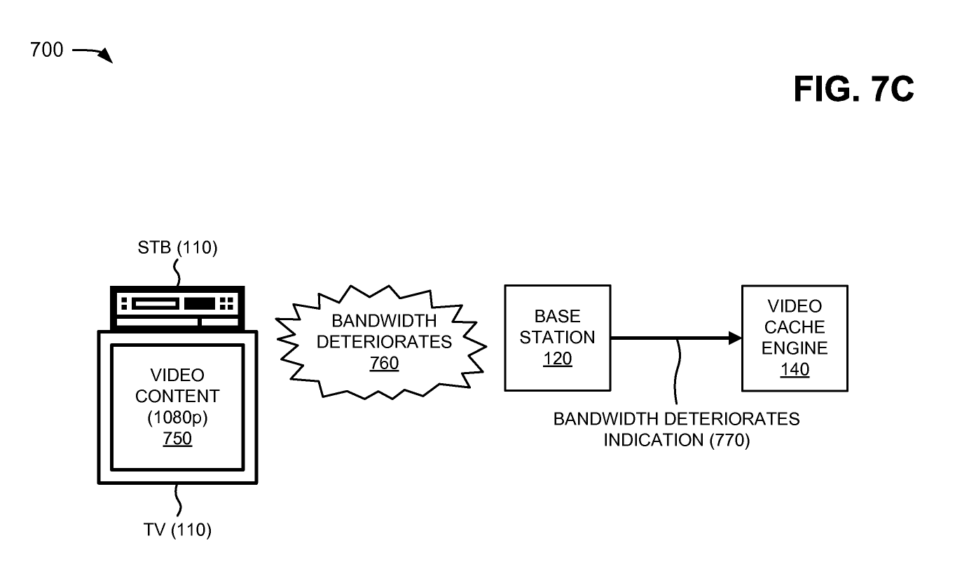

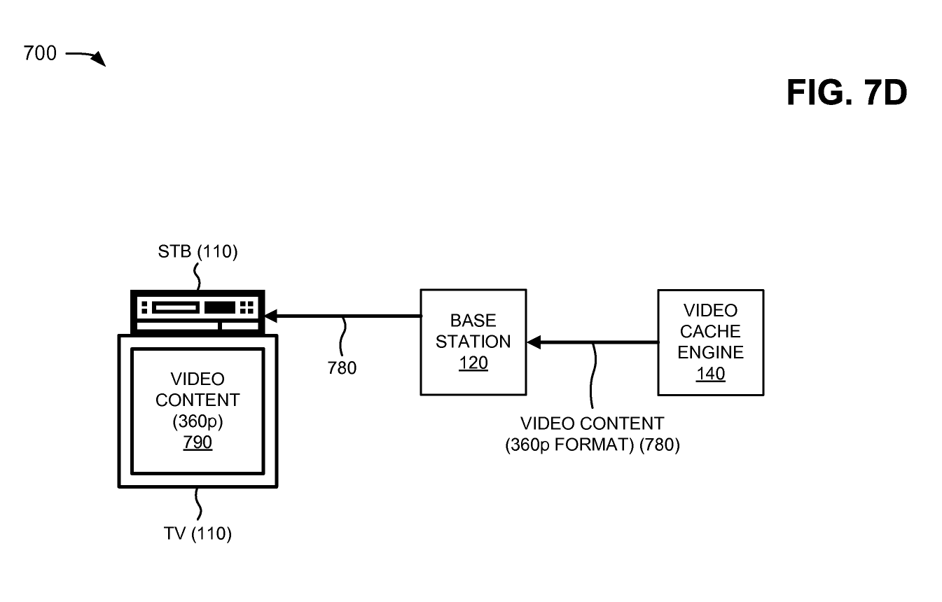

FIGS. 7A-7D are diagrams of example interactions between components of still another example portion 700 of network 100. As illustrated, example network portion 700 may include user device 110, base station 120, video cache engine 140, and video content provider 160. User device 110, base station 120, video cache engine 140, and video content provider 160 may include the features described above in connection with one or more of FIGS. 1-5. Furthermore, user device 110 depicted in FIGS. 7A-7D may correspond to fixed user device, such as a television 110 associated with a set-top box (STB) 110.

Television 110 may include a television monitor that is capable of displaying video content, television programming, content provided by STB 110, and/or content provided by other devices (e.g., a digital video disk (DVD) player, a video camera, etc., not shown) connected to television 110.

STB 110 may include a device that receives video content (e.g., from video cache engine 140 and/or video content provider 160), and provides the video content to television 110 or another device. STB 110 may record video content in a digital format to a disk drive or other memory medium within STB 110. In one example implementation, STB 110 may be incorporated directly within television 110 and/or may include a digital video recorder (DVR). In another implementation, television/STB 110 may be replaced with a computing device, such as a personal computer, a laptop computer, a tablet computer, etc.

With reference to FIG. 7A, a user of television/STB 110 may access a video content service (e.g., television programming provided by video content provider 160 to user device 110), and may be presented a variety of television channels on television 110. As shown in FIG. 7A, if the user selects a channel from the variety of channels presented on television 110, STB 110 may generate a video content request 710 for video content (e.g., in the 1080p format) associated with the selected channel. STB 110 may provide video content request 710 to base station 120, and base station 120 may forward video content request 710 to video cache engine 140 (e.g., via network device 130, not shown).

Video cache engine 140 may receive video content request 710 from base station 120, may generate a request 720 for the video content (e.g., in all formats, such as 1080p, 1080i, 760p, 760i, etc.) based on video content request 710, and may provide video content request 720 (e.g., for video content in all formats) to video content provider 160. Alternatively, if the video content requested by video content request 710 is already cached in video cache engine 140, video cache engine 140 may not generate video content request 720, but may retrieve the cached video content and render the video content to user device 110.

As further shown in FIG. 7A, video content provider 160 may provide the requested video content 730 (e.g., in all formats) to video cache engine 140. Video cache engine 140 may determine video content 740 (e.g., in the requested 1080p format) from video content 730 (e.g., in all formats) received from video content provider 160, and may provide video content 740 to base station 120 (e.g., via network device 130, not shown). Base station 120, in turn, may forward video content 740 to STB 110, as shown in FIG. 7B. STB 110 may receive video content 740 from base station 120 and may display video content 740 (e.g., in the 1080p format) on television 110, as indicated by reference number 750 in FIG. 7B.

If bandwidth conditions between user device 110 and base station 120 deteriorate (e.g., due to increased bandwidth usage by other subscribers), as indicated by reference number 760 in FIG. 7C, base station 120 may provide an indication 770 of the bandwidth deteriorating to vide cache engine 140, as further shown in FIG. 7C. Based on indication 770, video cache engine 140 may dynamically adapt a rate (e.g., a format or a quality) of video content 740 delivered to television/STB 110. For example, if the bandwidth (e.g., between television/STB 110 and base station 120) deteriorates, video cache engine 140 may change video content 740 from a 1080p format (e.g., a higher quality format) to video content 780 in a 360p format (e.g., a lower quality format), as shown in FIG. 7D. As further shown in FIG. 7D, video cache engine 140 may provide video content 780 (e.g., in the 360p format) to base station 120, and base station 120 may provide video content 780 to STB 110. STB 110 may display video content 780 in the 360p format on television 110, as indicated by reference number 790.

Although FIGS. 7A-7D show example components of network portion 700, in other implementations, network portion 700 may contain fewer components, different components, differently arranged components, and/or additional components than depicted in FIGS. 7A-7D. Alternatively, or additionally, one or more components of network portion 700 may perform one or more other tasks described as being performed by one or more other components of network portion 700.

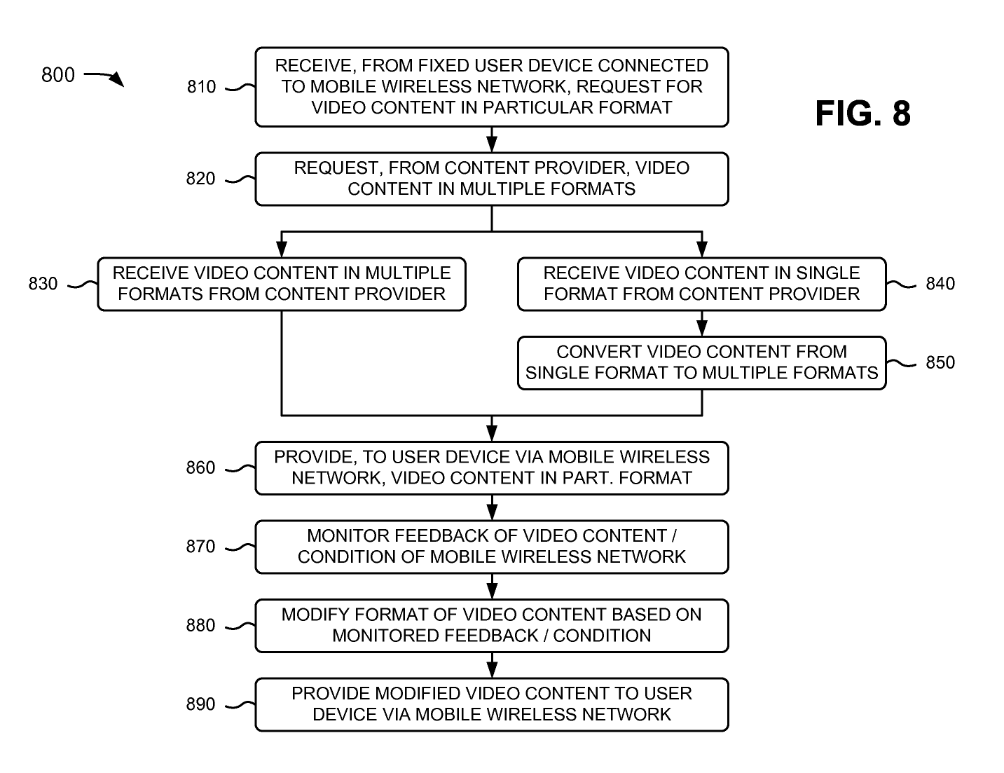

FIGS. 8-10 are flow charts of an example process 800 for optimizing video content delivery over mobile wireless networks according to implementations described herein. In one implementation, process 800 may be performed by video cache engine 140. In another implementation, some or all of process 80 may be performed by another device or group of devices, including or excluding video cache engine 140.

As illustrated in FIG. 8, process 800 may include receiving, from a fixed user device connected to a mobile wireless network, a request for video content in a particular format (block 810), and requesting, from a content provider, the requested video content in multiple formats (block 820). For example, in implementations described above in connection with FIG. 3, a user may utilize user device 110 to generate request 310 for video content (e.g., in a particular format, such as a 1080i format) to be displayed on user device 110. User device 110 may wirelessly provide (e.g., via base station 120 and/or network device 130) video content request 310 to video cache engine 140. Video content cache engine 140 may receive video content request 310 from user device 110, and may generate request 320 for the video content (e.g., in all formats, such as the 1080p, 1080i, 760p, 760i, etc. formats) based on video content request 310. In one example, if the user requests (e.g., via video content request 310) video content in a 760p format, video cache engine 140 may request (e.g., via video content request 320) video content in 1080p, 1080i, 760i, 480p, and 480i formats. Video cache engine 140 may provide video content request 320 to video content provider 160. Alternatively, if the video content requested by video content request 310 is already cached in video cache engine 140, video cache engine 140 may not generate video content request 320, but may retrieve the cached video content and render the video content to user device 110.

As further shown in FIG. 8, process 800 may include receiving the video content in multiple formats from the content provider (block 830). Alternatively, process 800 may include receiving the video content in a single format from the content provider (block 840), and converting the video content from the single format to multiple formats (block 850). For example, in implementations described above in connection with FIG. 5, video content provider 160 may provide video content 530 (e.g., in the format(s) requested by video content requests 520) to video cache engine 140 (e.g., via network 150). In one example, video content 530 may include the video content (e.g., requested by video content request 510) provided in all available formats (e.g., 1080p, 1080i, 720p, etc.). In another example, video content 530 may include the video content (e.g., requested by video content request 510) provided in an available format with the highest quality (e.g., the 1080p format). In such an example, video cache engine 140 (e.g., video format converter 420) may convert the video content provided in the single format (e.g., the 1080p format) to video content provided in all possible formats (e.g., 1080p, 1080i, 720p, etc.).

Returning to FIG. 8, process 800 may include providing, to the user device and via the mobile wireless network, the video content in the particular format (block 860), monitoring feedback associated with the video content and/or a condition of the mobile wireless network (block 870), modifying the format of the video content based on the monitored feedback and/or condition (block 880), and providing the modified video content to the user device via the mobile wireless network (block 890). For example, in implementations described above in connection with FIG. 5, video cache engine 140 may provide the video content (e.g., in the particular format requested by video content request 510) to user device 110 (e.g., via the wireless network provided by base station 120 and/or network device 130), as indicated by reference number 550. If user device 110 is mobile, radio conditions between user device 110 and base station 120 may continuously change. Alternatively, or additionally, if a load on base station 120 varies (e.g., based on bandwidth usage of other subscribers, time of day, etc.), radio conditions between user device 110 and base station 120 may change. This information (e.g., radio conditions, load on base station 120, wireless network congestion, etc.) may be provided from user device 110 to video cache engine 140 (e.g., via base station 120 and network device 130) as video content feedback 560. Based on video content feedback 560, video cache engine 140 may dynamically adapt a rate (e.g., a format or a quality) of video content 550 delivered to user device 110, as indicated by reference number 570. Video cache engine 140 may provide video content (e.g., in the modified format) to user device 110 (e.g., via base station 120 and network device 130), as indicated by reference number 580.

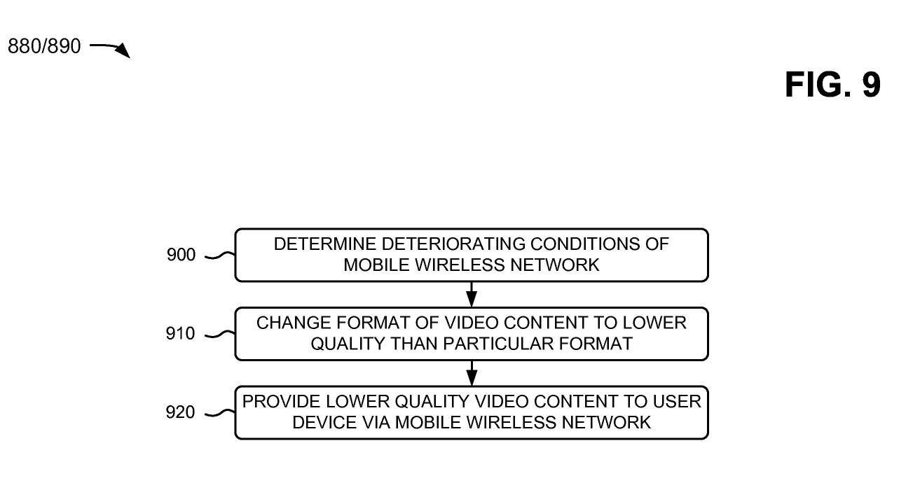

Process blocks 880/890 may include the process blocks depicted in FIG. 9. As shown in FIG. 9, process blocks 880/890 may include determining deteriorating conditions of the mobile wireless network (block 900), changing the format of the video content to a lower quality than the particular format (block 910), and providing the lower quality video content to the user device via the mobile wireless network (block 920). For example, in implementations described above in connection with FIG. 5, if user device 110 is mobile, radio conditions between user device 110 and base station 120 may continuously change. Alternatively, or additionally, if a load on base station 120 varies (e.g., based on bandwidth usage of other subscribers, time of day, etc.), radio conditions between user device 110 and base station 120 may change. This information (e.g., radio conditions, load on base station 120, wireless network congestion, etc.) may be provided from user device 110 to video cache engine 140 (e.g., via base station 120 and network device 130) as video content feedback 560. Based on video content feedback 560, video cache engine 140 may dynamically adapt a rate (e.g., a format or a quality) of video content 550 delivered to user device 110, as indicated by reference number 570. In one example, if the radio conditions (e.g., between user device 110 and base station 120) deteriorate, video content 550 may be changed from a 1080i format (e.g., a higher quality format) to a 360p format (e.g., a lower quality format). Video cache engine 140 may provide video content (e.g., in the modified format) to user device 110 (e.g., via base station 120 and network device 130), as indicated by reference number 580.

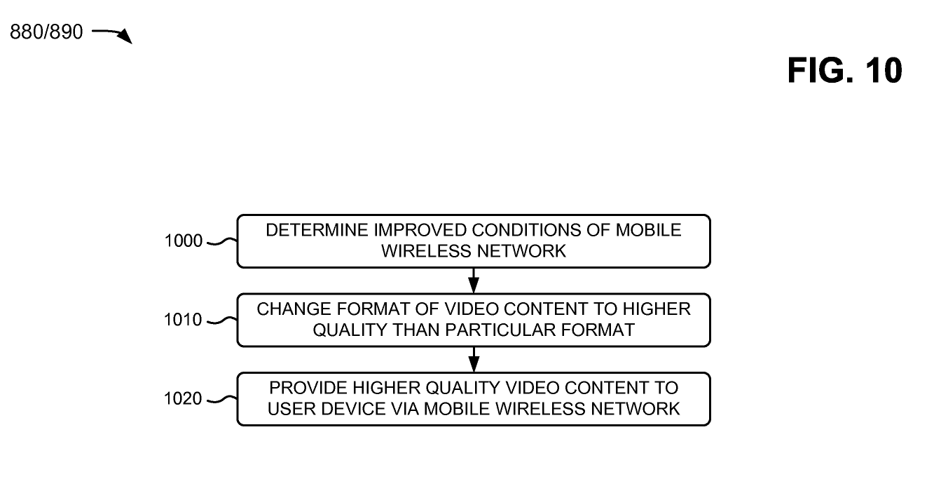

Alternatively, process blocks 880/890 may include the process blocks depicted in FIG. 10. As shown in FIG. 10, process blocks 880/890 may include determining improved conditions of the mobile wireless network (block 1000), changing the format of the video content to a higher quality than the particular format (block 1010), and providing the higher quality video content to the user device via the mobile wireless network (block 1020). For example, in implementations described above in connection with FIG. 5, based on video content feedback 560, video cache engine 140 may dynamically adapt a rate (e.g., a format or a quality) of video content 550 delivered to user device 110, as indicated by reference number 570. For example, if the radio conditions (e.g., between user device 110 and base station 120) improve, video content 550 may be changed from a 1080i format (e.g., a lower quality format) to a 1080p format (e.g., a higher quality format). Video cache engine 140 may provide video content (e.g., in the modified format) to user device 110 (e.g., via base station 120 and network device 130), as indicated by reference number 580.

Systems and/or methods described herein may optimize video content delivery over wireless networks. In one example implementation, the systems and/or methods may optimize television video content delivery via a mobile wireless network (e.g., as a last mile solution) to television customers provided in remote regions (e.g., regions that cannot be reached via conventional communication media, such as optical cables, copper cables, and/or other fixed wire-based technologies).

The foregoing description of implementations provides illustration and description, but is not intended to be exhaustive or to limit the invention to the precise form disclosed. Modifications and variations are possible in light of the above teachings or may be acquired from practice of the invention.

For example, while series of blocks have been described with regard to FIGS. 8-10, the order of the blocks may be modified in other implementations. Further, non-dependent blocks may be performed in parallel.

It will be apparent that example aspects, as described above, may be implemented in many different forms of software, firmware, and hardware in the implementations illustrated in the figures. The actual software code or specialized control hardware used to implement these aspects should not be construed as limiting. Thus, the operation and behavior of the aspects were described without reference to the specific software code—it being understood that software and control hardware could be designed to implement the aspects based on the description herein.

Further, certain portions of the invention may be implemented as “logic” that performs one or more functions. This logic may include hardware, such as an application specific integrated circuit or a field programmable gate array, or a combination of hardware and software.

Even though particular combinations of features are recited in the claims and/or disclosed in the specification, these combinations are not intended to limit the invention. In fact, many of these features may be combined in ways not specifically recited in the claims and/or disclosed in the specification.

No element, act, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A method implemented by a computing device, the method comprising:
receiving, by the computing device and from a fixed user device connected to a wireless network, a request for video content in a particular format;
requesting, by the computing device and from a content provider, the requested video content in multiple formats that include the particular format;
receiving, by the computing device and from the content provider, the video content in multiple formats; and
storing, by the computing device, the video content in the multiple formats, where the video content in the multiple formats is provided locally to the wireless network.

2. The method of claim 1, further comprising:
receiving, from the content provider, the video content in a single format; and
converting the video content in the single format to video content in the multiple formats.

3. The method of claim 1, further comprising:
selecting the video content in the particular format from the video content in the multiple formats; and
providing, to the user device and via the wireless network, the video content in the particular format.

4. The method of claim 1, further comprising:
receiving, from the user device, feedback associated with the video content in the particular format;
receiving a condition associated with the wireless network;
modifying the format of the video content based on the feedback and the condition; and
providing the video content in the modified format to the user device via the wireless network.

5. The method of claim 4, where:
the condition includes deteriorating radio conditions associated with the wireless network;
modifying the format includes changing the format of the video content to a lower quality format than the particular format; and
providing the video content includes providing the lower quality format video content to the user device via the wireless network.

6. The method of claim 4, where:
the condition includes improving radio conditions associated with the wireless network;
modifying the format includes changing the format of the video content to a higher quality format than the particular format; and
providing the video content includes providing the higher quality format video content to the user device via the wireless network.

7. The method of claim 1, where the user device includes one or more of:
a laptop computer provided in a particular location,
a personal computer provided in a particular location,
a tablet computer provided in a particular location,
a set-top box (STB) provided in a particular location,
a television provided in a particular location, or
a gaming system provided in a particular location.

8. The method of claim 1, further comprising:
identifying a user of the user device based on the video content request; and
determining whether the user subscribes to a service that enables the user to view the video content in the particular format.

9. The method of claim 8, further comprising:
providing, to the user device, the video content in the particular format when the user subscribes to a service that enables the user to view the video content in the particular format; and
providing, to the user device, the video content in a format different than the particular format when the user does not subscribe to a service that enables the user to view the video content in the particular format.

10. A device, comprising:
a memory to store a plurality of instructions; and
a processor to execute instructions in the memory to:
receive, from a fixed user device connected to a wireless network, a request for video content in a particular format,
retrieve the requested video content from the memory when the requested video content is stored in the memory,
request, from a content provider and when the requested video content is not stored in the memory, the requested video content in at least a single format,
receive, from the content provider, the video content in the single format,
convert the video content in the single format to video content in multiple formats that include the particular format, and
store, in the memory, the video content in the multiple formats, where the video content in the multiple formats is provided locally to the wireless network.

11. The device of claim 10, where the processor is further to execute instructions in the memory to:
receive, from the content provider, the video content in the multiple formats; and
omit the conversion of the video content in the single format.

12. The device of claim 10, where the processor is further to execute instructions in the memory to:
select the video content in the particular format from the video content in the multiple formats, and
provide, to the user device and via the wireless network, the video content in the particular format.

13. The device of claim 10, where the processor is further to execute instructions in the memory to:
receive, from the user device, feedback associated with the video content in the particular format,
receive a condition associated with the wireless network,
modify the format of the video content based on the feedback and the condition, and
provide the video content in the modified format to the user device via the wireless network.

14. The device of claim 13, where the condition includes deteriorating radio conditions associated with the wireless network, and the processor is further to execute instructions in the memory to:
change the format of the video content to a lower quality format than the particular format, and
provide the lower quality format video content to the user device via the wireless network.

15. The device of claim 13, where the condition includes improving radio conditions associated with the wireless network, and the processor is further to execute instructions in the memory to:
change the format of the video content to a higher quality format than the particular format, and
provide the higher quality format video content to the user device via the wireless network.

16. The device of claim 10, where the device includes a video cache engine.

17. The device of claim 10, where the fixed user device includes one or more of:
a laptop computer provided in a fixed location,
a personal computer provided in a fixed location,
a tablet computer provided in a fixed location,
a set-top box (STB) provided in a fixed location,
a television provided in a fixed location, or
a gaming system provided in a fixed location.

18. The device of claim 10, where the processor is further to execute instructions in the memory to:
identify a user of the user device based on the video content request, and
determine whether the user subscribes to a service that enables the user to view the video content in the particular format.

19. The device of claim 18, where the processor is further to execute instructions in the memory to:
provide, to the user device, the video content in the particular format when the user subscribes to a service that enables the user to view the video content in the particular format, and
provide, to the user device, the video content in a format different than the particular format when the user does not subscribe to a service that enables the user to view the video content in the particular format.

20. A set-top box (STB) provided in a particular location and associated with a wireless network, the STB comprising:
a memory to store a plurality of instructions; and
a processor to execute instructions in the memory to:
provide, to a video cache engine situated locally to a wireless network, a request for video content in a particular format,
receive, from the video cache engine and via the wireless network, the video content in the particular format,
provide, to the video cache engine, feedback associated with the video content in the particular format, where the video cache engine modifies the format of the video content based on the feedback, and
receive, from the video cache engine and via the wireless network, the video content in the modified format.
